(19) United States
(12) Patent Application Publication
(10) Pub. No.: US 2015/0339065 A1
(43) Pub. Date: Nov. 26, 2015

(54) ENHANCED DATA RELIABILITY USING SOLID-STATE MEMORY-ENABLED STORAGE DEVICES

(71) Applicants: MUNIF M. FARHAN, Round Rock, TX (US); ROCCO ANCONA, Austin, TX (US)

(72) Inventors: MUNIF M. FARHAN, Round Rock, TX (US); ROCCO ANCONA, Austin, TX (US)

(21) Appl. No.: 14/282,827

(22) Filed: May 20, 2014

(51) Int. Cl. G06F 3/06

(52) U.S. Cl. CPC G06F 3/0619; G06F 3/0679; G06F 3/0655; G06F 3/065; G06F 2206/1014

(57) ABSTRACT

Methods and systems for enhanced data reliability using solid-state memory-enabled storage devices may involve a solid-state hybrid drive (SSHD) with a safe zone in a solid-state memory. The safe zone may mirror a storage structure stored in a magnetic memory of the SSHD. When an error or failure in at least a portion of the magnetic memory occurs, the SSHD may continue to provide external access to the safe zone and may enable an information handling system to boot from the safe zone.

### BACKGROUND

1. Field of the Disclosure

This disclosure relates generally to information handling systems and more particularly to enhanced data reliability using solid-state memory-enabled storage devices.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

In many information handling systems, primary storage devices are implemented using hard disk drives, which operate using magnetic cylinders that spin at a high rate of rotation, and which are prone to failures at higher rates than solid-state memory (e.g., flash memory), which operates with no moving parts. In certain storage devices, referred to as a solid-state memory-enabled storage device, such as a “solid-state hybrid drive” or “SSHD”, solid-state memory is included as an internal cache memory to improve performance.

### SUMMARY

In one aspect, a disclosed method is for operating a solid-state hybrid drive. The solid-state hybrid drive may include a magnetic memory, a solid-state memory including a safe zone, and a host interface for communicating with a host controller. The method may include receiving an indication identifying a storage structure stored on the magnetic memory, identifying a safe zone in the solid-state memory, and maintaining the safe zone as a mirrored copy of the storage structure. The safe zone may be sized to accommodate the storage structure.

Other disclosed aspects include a solid-state hybrid drive, an information handling system including the solid-state hybrid drive, and an article of manufacture comprising a non-transitory computer-readable medium storing instructions executable by a processor.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram of selected elements of an embodiment of an information handling system for enhanced data reliability using solid-state memory-enabled storage devices;

FIG. 2 is a block diagram of selected elements of an embodiment of a storage architecture associated with enhanced data reliability using solid-state memory-enabled storage devices;

FIG. 3 is a block diagram of selected elements of an embodiment of a storage resource for enhanced data reliability using solid-state memory-enabled storage devices;

FIG. 4 is a flowchart depicting selected elements of an embodiment of a method for enhanced data reliability using solid-state memory-enabled storage devices; and

FIG. 5 is a flowchart depicting selected elements of an embodiment of a method for enhanced data reliability using solid-state memory-enabled storage devices.

### DESCRIPTION OF PARTICULAR EMBODIMENT(S)

In the following description, details are set forth by way of example to facilitate discussion of the disclosed subject matter. It should be apparent to a person of ordinary skill in the field, however, that the disclosed embodiments are exemplary and not exhaustive of all possible embodiments.

For the purposes of this disclosure, an information handling system may include an instrumentality or aggregate of instrumentalities operable to compute, classify, process, transmit, receive, retrieve, originate, switch, store, display, manifest, detect, record, reproduce, handle, or utilize various forms of information, intelligence, or data for business, scientific, control, entertainment, or other purposes. For example, an information handling system may be a personal computer, a PDA, a consumer electronic device, a network storage device, or another suitable device and may vary in size, shape, performance, functionality, and price. The information handling system may include memory, one or more processing resources such as a central processing unit (CPU) or hardware or software control logic. Additional components or the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

Additionally, the information handling system may include firmware for controlling and/or communicating with, for example, hard drives, network circuitry, memory devices, I/O devices, and other peripheral devices. As used in this disclosure, firmware includes software embedded in an information handling system component used to perform predefined tasks. Firmware is commonly stored in non-volatile memory, or memory that does not lose stored data upon the loss of power. In certain embodiments, firmware associated with an information handling system component is stored in non-volatile memory that is accessible to one or more information handling system components. In the same or alternative embodiments, firmware associated with an information handling system component is stored in non-volatile memory that is dedicated to and comprises part of that component.

For the purposes of this disclosure, computer-readable media may include an instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or solid-state memory (SSD), such as flash memory, as well as communications media such wires, optical fibers, microwaves, radio waves, and other electromagnetic and/or optical carriers; and/or any combination of the foregoing.

As noted previously, certain information handling systems may include solid-state hybrid drives (SSHD) that include magnetic memory (e.g., one or more magnetic cylinders and/or other types of magnetic media) and a solid-state memory and are also referred to herein as solid-state memory-enabled storage devices. The solid-state memory may be a flash memory. The solid-state memory may be used by the SSHD as a cache to improve performance of input/output operations for data written to/read from the SSHD. As will be described in further detail, the inventors of the present disclosure have discovered a method and system for enhanced data reliability using solid-state memory-enabled storage devices. According to the methods described herein, a safe zone may be allocated on the solid-state memory and may be used to mirror a storage structure that is also stored on the magnetic memory.

The SSHD may mirror the storage structure on the solid-state memory. When a failure occurs in the SSHD, the SSHD may be enabled to access the safe zone and/or provide external access via a host controller to the safe zone, which is referred to herein as ‘recovery access’. It is noted that recovery access may include booting from the safe zone, when the storage structure is bootable.

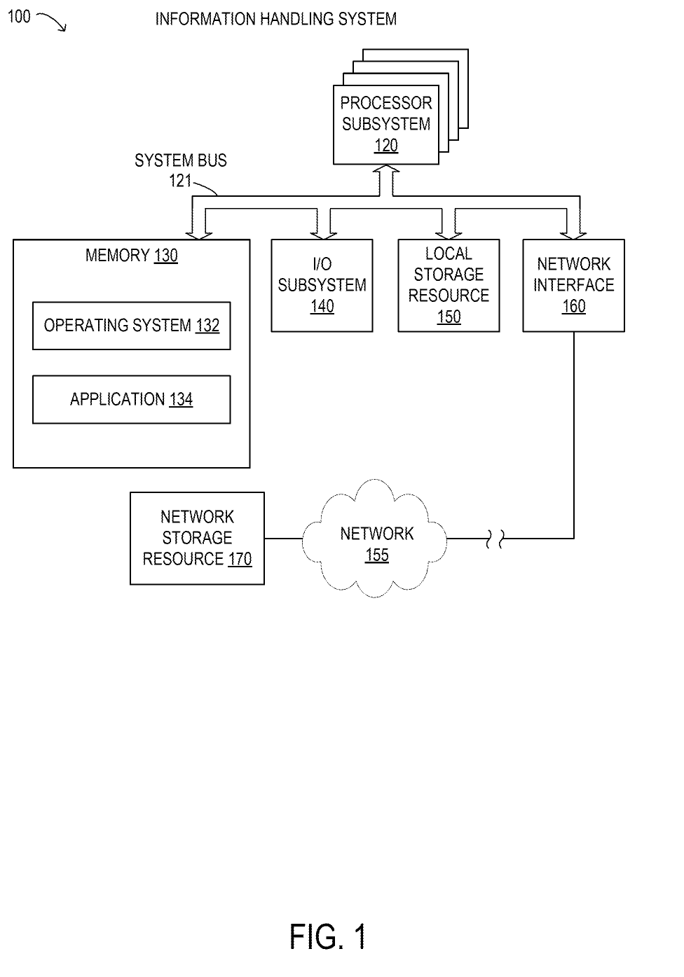

Particular embodiments are best understood by reference to FIGS. 1, 2, 3, 4 and 5 wherein like numbers are used to indicate like and corresponding parts.

Turning now to the drawings, FIG. 1 illustrates a block diagram depicting selected elements of an embodiment of information handling system 100. Also shown with information handling system 100 are external or remote elements, namely, network 155 and network storage resource 170.

As shown in FIG. 1, components of information handling system 100 may include, but are not limited to, processor subsystem 120, which may comprise one or more processors, and system bus 121 that communicatively couples various system components to processor subsystem 120 including, for example, memory 130, I/O subsystem 140, local storage resource 150, and network interface 160. System bus 121 may represent a variety of suitable types of bus structures, e.g., a memory bus, a peripheral bus, or a local bus using various bus architectures in selected embodiments. For example, such architectures may include, but are not limited to, Micro Channel Architecture (MCA) bus, Industry Standard Architecture (ISA) bus, Enhanced ISA (EISA) bus, Peripheral Component Interconnect (PCI) bus, PCI-Express bus, HyperTransport (HT) bus, and Video Electronics Standards Association (VESA) local bus.

In FIG. 1, network interface 160 may be a suitable system, apparatus, or device operable to serve as an interface between information handling system 100 and a network 155. Network interface 160 may enable information handling system 100 to communicate over network 155 using a suitable transmission protocol and/or standard, including, but not limited to, transmission protocols and/or standards enumerated below with respect to the discussion of network 155. In some embodiments, network interface 160 may be communicatively coupled via network 155 to network storage resource 170. Network 155 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or another appropriate architecture or system that facilitates the communication of signals, data and/or messages (generally referred to as data). Network 155 may transmit data using a desired storage and/or communication protocol, including, but not limited to, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or another transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 155 and its various components may be implemented using hardware, software, or any combination thereof. In certain embodiments, information handling system 100 and network 155 may be included in a rack domain.

As depicted in FIG. 1, processor subsystem 120 may comprise a system, device, or apparatus operable to interpret and/or execute program instructions and/or process data, and may include a microprocessor, microcontroller, digital signal processor (DSP), application specific integrated circuit (ASIC), or another digital or analog circuitry configured to interpret and/or execute program instructions and/or process data. In some embodiments, processor subsystem 120 may interpret and/or execute program instructions and/or process data stored locally (e.g., in memory 130 and/or another component of physical hardware 102). In the same or alternative embodiments, processor subsystem 120 may interpret and/or execute program instructions and/or process data stored remotely (e.g., in a network storage resource).

Also in FIG. 1, memory 130 may comprise a system, device, or apparatus operable to retain and/or retrieve program instructions and/or data for a period of time (e.g., computer-readable media). As shown in the example embodiment of FIG. 1, memory 130 stores operating system 132 and application 134. Operating system 132 may represent instructions executable by processor subsystem 120 to operate information handling system 100 after booting. It is noted that in different embodiments, operating system 132 may be stored at network storage resource 170 and may be accessed by processor subsystem 120 via network 155 Application 134 may represent instructions executable by processor subsystem 120 for implementing generic application functionality, which may include a user interface and/or access to computing resources, such as local storage resource 150, for example. Memory 130 may comprise random access memory (RAM), electrically erasable programmable read-only memory (EEPROM), a PCMCIA card, solid-state memory, magnetic storage, opto-magnetic storage, and/or a suitable selection and/or array of volatile or non-volatile memory that retains data after power to its associated information handling system, such as information handling system 100, is powered down.

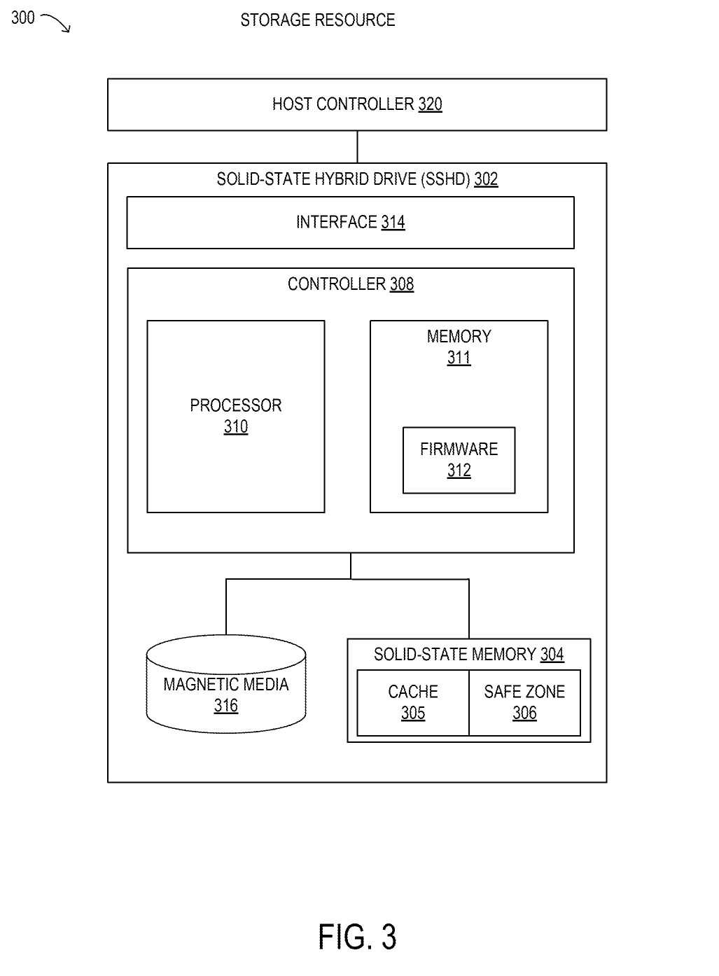

Local storage resource 150 may comprise computer-readable media (e.g., hard disk drive, floppy disk drive, CD-ROM, and/or other type of rotating storage media, solid-state memory, EEPROM, and/or another type of solid state storage media) and may be generally operable to store instructions and/or data. In particular embodiments, local storage resource 150 may include a solid-state hybrid drive (SSHD) that includes both magnetic memory and solid-state memory (see also FIG. 3). For example, local storage resource 150 may store executable code in the form of program files that may be loaded into memory 130 for execution. In information handling system 100, I/O subsystem 140 may comprise a system, device, or apparatus generally operable to receive and/or transmit data to/from/within information handling system 100. I/O subsystem 140 may represent, for example, a variety of communication interfaces, graphics interfaces, video interfaces, user input interfaces, and/or peripheral interfaces. In certain embodiments, I/O subsystem 140 may comprise a touch panel and/or a display adapter. The touch panel (not shown) may include circuitry for enabling touch functionality in conjunction with a display (not shown) that is driven by display adapter (not shown).

In operation, operating system 132 and/or application 134 may be configured to access a particular storage structure stored on local storage resource 150. Local storage resource 150 may include a solid-state memory-enabled storage device (i.e., a solid-state hybrid drive (SSHD)), as described herein. An indication may be sent to the SSHD specifying the storage structure that is stored in a magnetic memory of the SSHD. The SSHD may identify a safe zone in the solid-state memory. In some instances, the SSHD may allocate the safe zone. The safe zone may be sized to at least accommodate the storage structure. The SSHD may maintain the safe zone as a mirrored copy of the storage structure. In certain embodiments, the indication may specify that the safe zone is directly accessed by input/output operations for the storage structure, such that mirroring operations are performed to update the magnetic memory. At least a portion of the solid-state memory may include a cache for input/output operations intended for the SSHD. When a failure occurs that renders at least a portion of the magnetic memory inaccessible, the SSHD may provide recovery access to the solid-state memory, which may include read operations and write operations, and may also include booting from the safe zone. In some embodiments, when the storage structure stored in the magnetic memory is corrupted, the SSHD may restore the storage structure from the mirrored copy stored in the safe zone. When the storage structure is bootable, such as a bootable partition, the recovery access provided by the SSHD may enable an information handling system to boot from the safe zone.

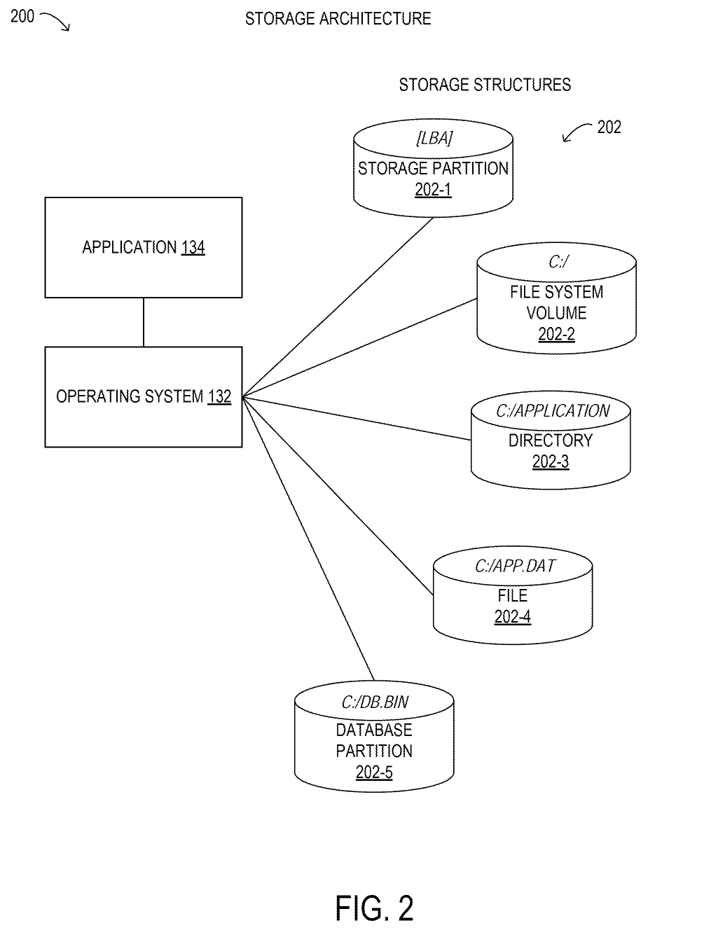

Turning now to FIG. 2, a block diagram of selected elements of an embodiment of storage architecture 200 is depicted. As shown, storage architecture 200 includes application 134 and operating system 132, which may access storage structures 202. Operating system 132 may include various device drivers for supporting host interfaces (see FIG. 3) that provide connectivity to various storage devices, including SSHDs. Operating system 132 may support and/or include a file system (not shown) for logical representation of file system objects in a storage partition installed on a storage device. Application 134 may access storage structures 202 using the drivers and/or the file system via operating system 132. In some embodiments, application 134 may directly access storage structures 202.

As shown in FIG. 2, storage structures 202 may represent various types of storage structures 202 for storing data on a storage device. It is noted that storage structures 202 may be stored on any type of storage device, whether conventional or hybrid, for example. Specifically, the various non-limiting exemplary embodiments of storage structures 202 in FIG. 2 may represent examples of organizing accessible digital data on a storage device. As shown in FIG. 2, storage partition 202-1 may represent a storage structure that includes a defined partition that is organized using logical block addressing (LBA). File system volume 202-2 may represent a storage structure that includes a volume with a file system installed for accessing storage using file system objects, which may include directory 202-3 and/or file 202-4 as further examples of storage structures. Database partition 202-5 may represent a storage structure that is a binary object, for example, a binary file, within which a database application has created a non-transparent internal partition for managing structured data. In certain embodiments, various combinations of storage structures 202 may be used. For example, a database application may be installed in part under a file system, using files and directories, but may also use a database partition for the structured data for one or more databases. As will be described in further detail, any one or more of storage structures 202 may be stored in a safe zone on a solid-state memory within a SSHD for purposes of reliability and/or data security.

Turning now to FIG. 3, a block diagram of selected elements of an embodiment of storage resource 300 is depicted. As shown in FIG. 3, storage resource 300 may represent, at least in part, an embodiment of local storage resource 150 and/or network storage resource 170 (see FIG. 1). As shown, storage resource 300 includes host controller 320 and solid-state hybrid drive (SSHD) 302, which may communicate over a data bus supported by host controller 320 and interface 314 included in SSHD 302. Thus, operating system 132, for example, may support host controller 320 and may enable application 134 (and/or other resources) to access SSHD 302 via host controller 320.

SSHD 302, as shown in FIG. 3, may further include controller 308, which may comprise processor 310 and memory 311. Memory 311 may be similar to memory 130 (see FIG. 1) while processor 310 may be enabled to control and access various components included within SSHD 302. Memory 311 is shown including firmware 312, which may represent instructions executable by processor 310 to implement functionality of controller 308 and/or SSHD 302, as described herein. As shown, controller 308 may access magnetic media 316 and solid-state memory 304. Magnetic media 316 may represent an element of magnetic storage that is commonly used in storage devices, which may include various numbers of magnetic cylinders. Thus, although depicted in FIG. 3 as a single element for descriptive clarity, magnetic media 316 may represent a plurality of elements in various embodiments. Magnetic media 316 may be divided into sectors and blocks, for example, for logical block addressing using a magnetic head and associated electro-mechanical components (not shown) while magnetic media 316 spins at a given angular velocity. Solid-state memory 304 may be included within SSHD 302 to provide caching functionality for input/output operations via interface 314 to host controller 320 using cache 305. As shown, solid-state memory 304 has been partitioned such that cache 305 consumes a portion of the full capacity of solid-state memory 304, while safe zone 306 has also been allocated in solid-state memory 304. The respective portions of solid-state memory 304 consumed by cache 305 and/or safe zone 306 may vary in different embodiments. In one embodiment, solid-state memory 304 has 16 Gigabyte (Gb) full capacity, while cache 305 consumes 8 Gb and safe zone 306 consumes 8 Gb. Other allocations of cache 305 and safe zone 306 within solid-state memory 304 may be used in different embodiments.

In operation of storage resource 300, a user and/or an application may send an indication of a particular storage structure (not shown in FIG. 3, see FIG. 2) that is stored on magnetic memory, represented by magnetic media 316, on SSHD 302. The indication may be sent to controller 308 via host controller 320, which may identify the storage structure in the magnetic memory and may identify that safe zone 306 is sized to accommodate the storage structure. Then, controller 308 may mirror the storage structure on safe zone 306, by creating and/or maintaining a mirrored copy (not shown) of the storage structure in safe zone 306. In one embodiment, mirroring the storage structure by controller 308 may involve duplicating each input/output operation for the storage structure for both magnetic media 316 and safe zone 306. It is noted that either magnetic media 316 or safe zone 306 may serve as the primary storage device for the storage structure during operation. In some embodiments, the indication may specify that safe zone 306 is the primary storage device and is directly accessed by host controller 320, while controller 308 mirrors safe zone 306 to magnetic media 316. In this manner, safe zone 306 may maintain a redundant copy of the storage structure.

When a serious error occurs and at least a portion of magnetic media 316 is no longer accessible, for various reasons (e.g., hardware, software, data errors), controller 308 may be enabled to provide continued access to safe zone 306 via interface 314 to host controller 320. When the storage structure stored in magnetic media 316 is corrupted, for example due to a file system error, controller 308 may be enabled to restore the storage structure from the mirrored copy stored in safe zone 306. It is noted that, in certain embodiments, operating system 132 may itself be stored in magnetic media 316, such that SSHD 302 is a bootable device. In such instances, SSHD 302 may be booted from another operating system (from another storage device, or in another information handling system) supporting host controller 320, such that safe zone 306 may still be accessed to retrieve the mirrored copy of the storage structure. In some embodiments, safe zone 306 may be bootable, for example, when the storage structure includes a bootable partition. In this manner, reliability of the storage structure stored in safe zone 306 may be enhanced in many different operational scenarios, which may be beneficial to a user of the storage structure.

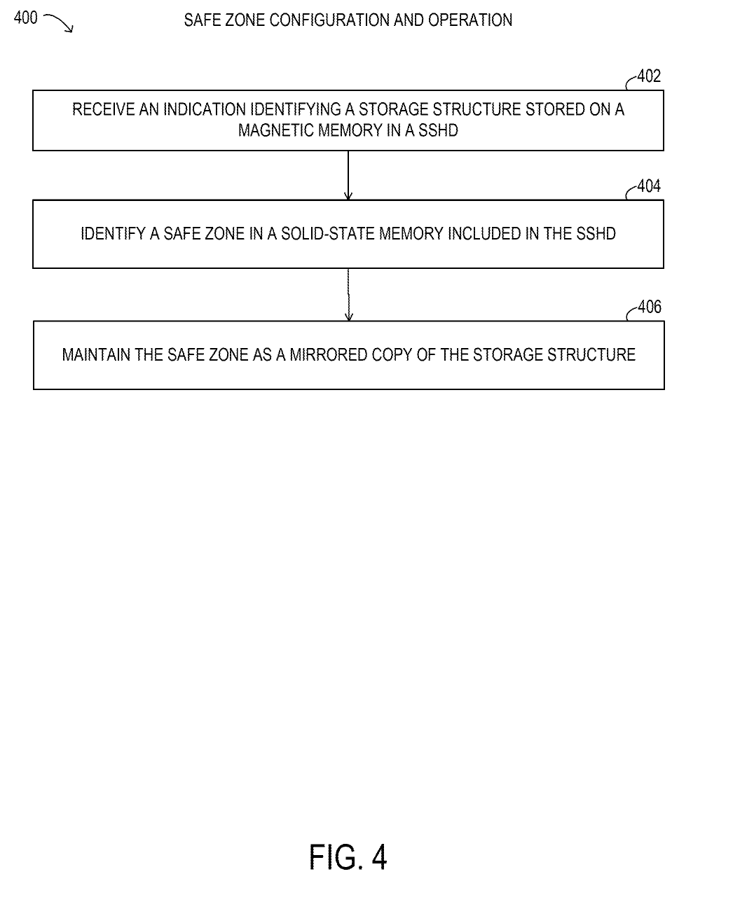

Referring now to FIG. 4, a block diagram of selected elements of an embodiment of method 400 for enhanced data reliability using solid-state memory-enabled storage devices is depicted in flowchart form. Method 400 may describe safe zone configuration and operation and may be performed using information handling system 100 (see FIG. 1), storage architecture 200 (see FIG. 2), and storage resource 300 (see FIG. 3). It is noted that certain operations described in method 400 may be optional or may be rearranged in different embodiments. Method 400 may begin by receiving (operation 402) an indication identifying a storage structure stored on a magnetic memory in a solid-state hybrid drive (SSHD). Then, a safe zone may be identified (operation 404) in a solid-state memory included in the SSHD. The safe zone may be sized to accommodate the storage structure. The safe zone may be maintained (operation 406) as a mirrored copy of the storage structure.

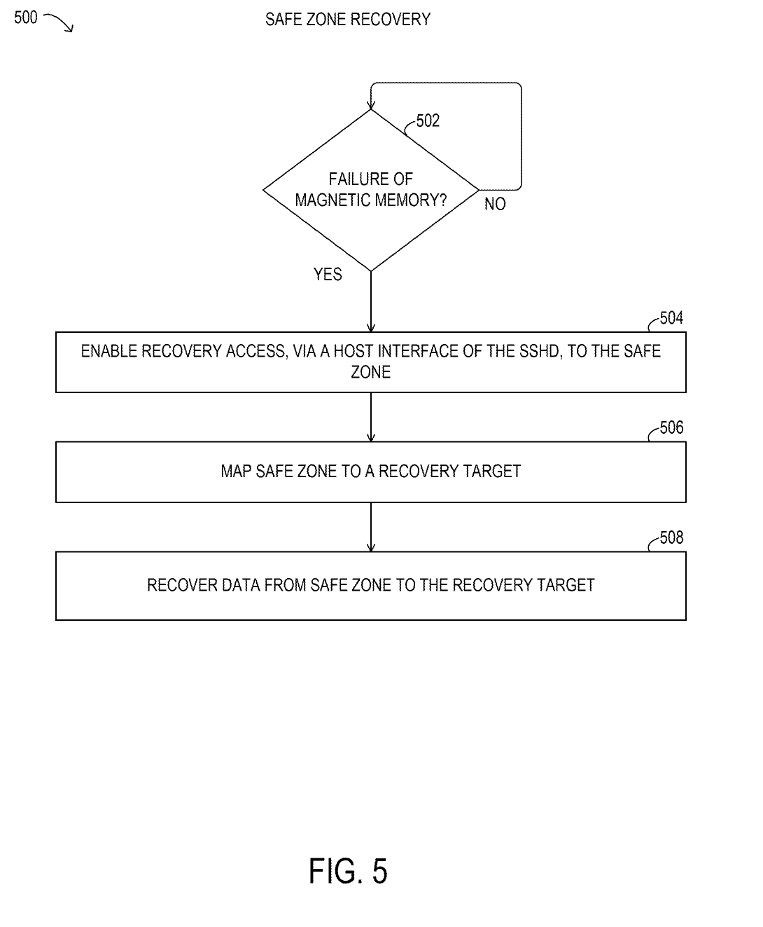

Referring now to FIG. 5, a block diagram of selected elements of an embodiment of method 500 for enhanced data reliability using solid-state memory-enabled storage devices is depicted in flowchart form. Method 500 may describe safe zone recovery and may be performed using information handling system 100 (see FIG. 1), storage architecture 200 (see FIG. 2), and storage resource 300 (see FIG. 3). It is noted that certain operations described in method 500 may be optional or may be rearranged in different embodiments. Method 500 may begin with a decision whether a magnetic memory has failed (operation 502). When a result of operation 502 is NO, method 500 may loop back to operation 502. When a result of operation 502 is YES, recovery access, via a host interface of the SSHD, may be enabled (operation 504). Recovery access may involve providing external access to the safe zone, and may include operations 506 and 508. Then, the safe zone may be mapped (operation 506) to a recovery target. The recovery target may be the magnetic memory. The recovery target may be another storage device. The mapping in operation 506 may be performed internally by the SSHD. The mapping in operation 506 may be performed externally at an application. Data may be recovered (operation 508) from the safe zone to the recovery target. In certain embodiments, recovery access may involve booting an information handling system from the safe zone in addition to, or in substitution of, operations 506 and 508.

Methods and systems for enhanced data reliability using solid-state memory-enabled storage devices may involve a solid-state hybrid drive (SSHD) with a safe zone in a solid-state memory. The safe zone may mirror a storage structure stored in a magnetic memory of the SSHD. When an error or failure in at least a portion of the magnetic memory occurs, the SSHD may continue to provide external access to the safe zone and may enable an information handling system to boot from the safe zone.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for operating a storage device, the storage device comprising:
a magnetic memory;
a solid-state memory including a safe zone; and
a host interface for communicating with a host controller,
the method comprising:
receiving an indication identifying a storage structure stored on the magnetic memory;
identifying a safe zone in the solid-state memory, wherein the safe zone is sized to accommodate the storage structure; and
maintaining the safe zone as a mirrored copy of the storage structure.

2. The method of claim 1, further comprising:
when a failure in at least a portion of the magnetic memory is detected, enabling recovery access, via the host interface, to the safe zone.

3. The method of claim 2, wherein the recovery access includes read operations and write operations.

4. The method of claim 2, wherein the recovery access includes booting an information handling system from the safe zone.

5. The method of claim 1, further comprising:
when a corruption of the storage structure stored in the magnetic memory is detected, restoring the storage structure on the magnetic memory from the mirrored copy stored on the safe zone.

6. The method of claim 1, wherein the indication specifies directly accessing the safe zone by input/output operations for the storage structure.

7. The method of claim 1, wherein identifying the safe zone includes:
allocating the safe zone in the solid-state memory.

8. The method of claim 1, wherein the storage structure includes at least one of:
a storage partition;
a file system volume;
a file system object;
a database partition; and
a binary data object.

9. The method of claim 1, wherein the solid-state memory includes a cache for input/output operations for the magnetic memory.

10. A storage device, comprising:
a magnetic memory;
a solid-state memory including a safe zone;
a host interface for communicating with a host controller;
a processor having access to the host interface and access to a memory storing instructions executable by the processor; and
the memory, wherein the memory stores instructions that, when executed by the processor, cause the processor to:
receive an indication identifying a storage structure stored on the magnetic memory;
identify a safe zone in the solid-state memory, wherein the safe zone is sized to accommodate the storage structure; and
maintain the safe zone as a mirrored copy of the storage structure.

11. The storage device of claim 10, further comprising instructions to:
when a failure in at least a portion of the magnetic memory is detected, enable recovery access, via the host interface, to the safe zone.

12. The storage device of claim 11, wherein the recovery access includes read operations and write operations.

13. The storage device of claim 11, wherein the recovery access includes booting an information handling system from the safe zone.

14. The storage device of claim 10, further comprising instructions to:
when a corruption of the storage structure stored in the magnetic memory is detected, restore the storage structure on the magnetic memory from the mirrored copy stored on the safe zone.

15. The storage device of claim 10, wherein the indication specifies directly accessing the safe zone by input/output operations for the storage structure.

16. The storage device of claim 10, wherein the instructions to identify the safe zone include instructions to:
allocate the safe zone in the solid-state memory.

17. The storage device of claim 10, wherein the storage structure includes at least one of:
a storage partition;
a file system volume;
a file system object;
a database partition; and
a binary data object.

18. The storage device of claim 10, wherein the solid-state memory includes a cache for input/output operations for the magnetic memory.

19. An information handling system, comprising:
a storage device, including:
a magnetic memory;
a host interface for communicating with a host controller; and
a solid-state memory including a safe zone;
a processor subsystem having access to a memory, wherein the memory stores instructions that, when executed by the processor subsystem, cause the processor subsystem to:
receive an indication identifying a storage structure stored on the magnetic memory; and
instruct to the storage device to:
identify the safe zone in the solid-state memory, wherein the safe zone is sized to accommodate the storage structure; and
maintain the safe zone as a mirrored copy of the storage structure.

20. The information handling system of claim 19, further comprising:
the memory, wherein the instructions include at least a portion of an operating system, including a file system for providing access to the storage device, wherein the storage structure is accessible via the file system.

21. The information handling system of claim 19, wherein the indication specifies direct access to the safe zone by input/output operations for the storage structure.

22. The information handling system of claim 19, wherein the indication is received as user input from a user.

23. The information handling system of claim 19, wherein the storage device is to:
when a failure in at least a portion of the magnetic memory is detected, enable recovery access, via the host interface, to the safe zone.
